(19) United States
(12) Patent Application Publication
(10) Pub. No.: US 2026/0092822 A1
(43) Pub. Date: Apr. 2, 2026

(54) TIRE-AXLE-FORCE MEASURING APPARATUS

(71) Applicant: SUBARU CORPORATION, Tokyo (JP)

(72) Inventors: Jun TANAKA, Tokyo (JP); Naoto SATO, Tokyo (JP)

(21) Appl. No.: 19/336,933

(22) Filed: Sep. 23, 2025

(30) Foreign Application Priority Data
Oct. 2, 2024 (JP) 2024-173036

(51) Int. Cl. G01L 5/00; G01M 17/007

(52) U.S. Cl. CPC G01L 5/00; G01M 17/007

(57) ABSTRACT

A tire-axle-force measuring apparatus includes a trailer to which testing tires are attached; a towing vehicle configured to tow the trailer; a load cell configured to measure an axle force applied to an axle supporting the tire; a heavy construction to each of two vehicle-width-direction sides of which the load cell is fixed; an accelerometer attached to the load cell at a position close to the axle and configured to measure an acceleration acting on an axial center of the axle; and an axle-force calculator configured to calculate a revised axle force compensated for with an inertial force, the inertial force being the acceleration detected by the accelerometer and multiplied by a mass of the load cell at the position close to the axle, the revised axle force being the sum of the axle force measured by the load cell and the inertial force.

### CROSS-REFERENCE TO RELATED APPLICATIONS

The present application claims priority from Japanese Patent Application No. 2024-173036 filed on October 2, 2024, the entire contents of which are hereby incorporated by reference.

### BACKGROUND

The disclosure relates to a tire-axle-force measuring apparatus.

A technique is known in which a chassis dynamometer measures a dynamic load acting on an axle supporting a rotating tire. However, the value measured by the chassis dynamometer is not the one obtained for a vehicle that is actually traveling on a road surface. Therefore, such a measured value is different from a value obtained for a vehicle that is traveling on an actual road surface.

A technique of measuring a dynamic load acting on an axle supporting a tire of a vehicle traveling on an actual road surface is disclosed in, for example, Japanese Unexamined Patent Application Publication (JP-A) No. 2006-30046. In JP-A No. 2006-30046, a tire to be tested (hereinafter referred to as a testing tire) is attached to an axle of a trailer, and a towing vehicle is caused to travel while towing the trailer. During the travel, an arithmetic device measures through a load cell the impact force applied to the axle when the tire goes over irregularities in the road surface.

### SUMMARY

An aspect of the disclosure provides a tire-axle-force measuring apparatus including a trailer to which testing tires are attached; a towing vehicle configured to tow the trailer; and a load cell configured to measure an axle force applied to an axle supporting the tire. The tire-axle-force measuring apparatus further includes a heavy construction to each of two sides of which the load cell is fixed, the two sides being located opposite each other in a vehicle width direction; an accelerometer attached to the load cell at a position close to the axle and configured to measure an acceleration acting on an axial center of the axle; and an axle-force calculator configured to calculate a revised axle force compensated for with an inertial force, the inertial force being the acceleration detected by the accelerometer and multiplied by a mass of the load cell at the position close to the axle, the revised axle force being the sum of the axle force measured by the load cell and the inertial force.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a side view of a tire-axle-force measuring apparatus, illustrating an overall configuration thereof;

FIG. 2 is a plan view of the tire-axle-force measuring apparatus illustrated in FIG. 1;

FIG. 3 is a rear view of a trailer;

FIG. 4 is a front view of the trailer;

FIG. 5 schematically illustrates a heavy construction with load cells and accelerometers attached thereto;

FIG. 6 is a block diagram of an axle-force-measurement arithmetic unit;

FIG. 7 is a graph illustrating the axle force acting in the front-rear direction on an axle versus frequency; and

FIG. 8 is a graph illustrating the axle force acting in a direction along the axle versus frequency.

### DETAILED DESCRIPTION

The trailer disclosed in JP-A No. 2006-30046 is an assembly of frame members. Therefore, the trailer tends to cause an elastic resonance phenomenon. When a part supporting the load cell resonates, an appropriate measurement value cannot be obtained, making it difficult to measure a high-frequency component of the dynamic load.

Furthermore, to apply an appropriate surface pressure to the ground contact surface of the tire, the trailer needs to have a mass substantially equivalent to the axle load of the actual vehicle. Nevertheless, rigid-body resonance inevitably occurs because of the vertical spring of the tire and the mass of the trailer. If the trailer causes a significant rigid-body resonance, the area of the tire contact surface greatly fluctuates, making it difficult to obtain an accurate measurement value.

During the travel, the towing vehicle also vibrates because of irregularities in the road surface, and a dynamic load is transmitted to the trailer through a vehicle-side coupler. Such a dynamic load transmitted through the vehicle-side coupler is superposed on a dynamic load transmitted through the testing tire, and the resulting load is detected by the load cell. Therefore, it is difficult to accurately measure the characteristics of the testing tire.

It is desirable to provide a tire-axle-force measuring apparatus capable of accurately measuring a dynamic load applied to an axle through a testing tire, while suppressing the influence of the rigid-body resonance of a trailer traveling with the testing tire attached thereto and the influence of the vibration from a towing vehicle within a frequency range of about 20 Hz to about 400 Hz.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

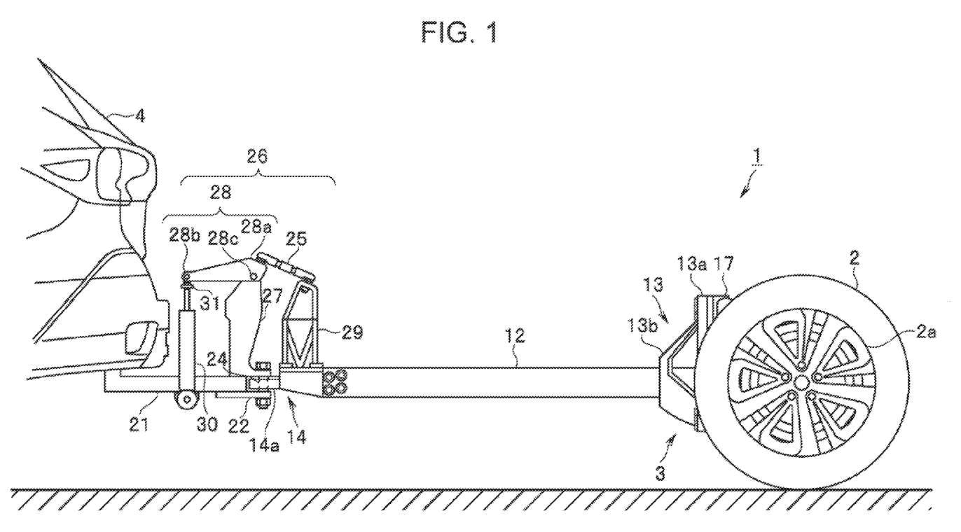

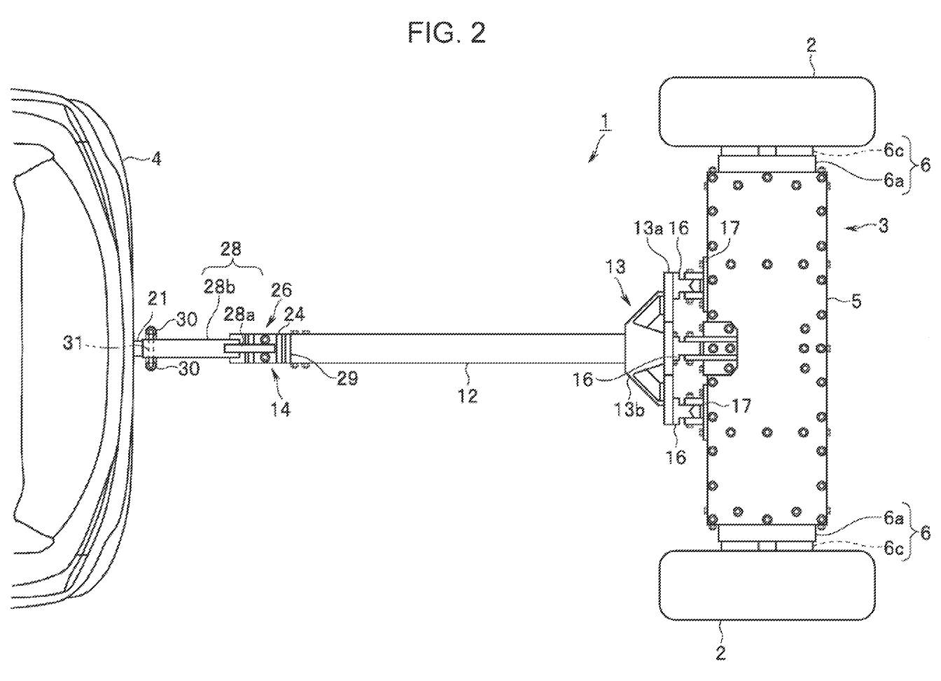

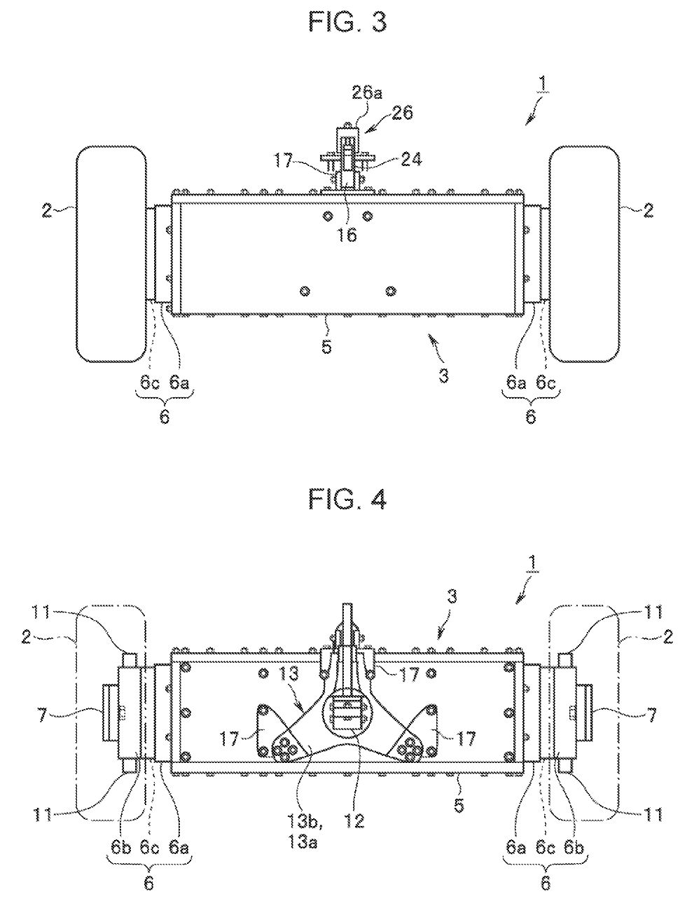

Referring to FIGS. 1 and 2, a tire-axle-force measuring apparatus 1 includes a trailer 3 to which wheels 2a of testing tires 2 are attached on two respective opposite sides, and a towing vehicle 4 configured to tow the trailer 3.

The trailer 3 includes a heavy construction 5. The heavy construction 5 has a rectangular parallelepiped shape elongated horizontally in the vehicle width direction. The heavy construction 5 is set to have a mass substantially equivalent to the front axle load or rear axle load of an actual vehicle to which the tires 2 are to be attached. Thus, a load substantially the same as that for the actual vehicle is applied to the two tires 2.

The resonance frequency of the heavy construction 5 is set to a high value. The set resonance frequency is higher than the highest frequency of road noise that is received from the road surface through the tires 2. For example, if the upper limit of the road-noise frequency range is 400 [Hz], the resonance frequency of the heavy construction 5 is set to 600 [Hz] or above, which is about 1.5 times the upper limit of the road-noise frequency range. The heavy construction 5 is an assembly of relatively thick steel plates that are fastened together with bolts in such a manner as to have a predetermined resonance frequency. A mass member is fixedly disposed inside the heavy construction 5. The mass member is intended to adjust the axle weight (the mass of the axle).

Load cells 6 are fixed to the left and right faces of the heavy construction 5 at respective positions where corresponding axles 7 are supported. As illustrated in FIG. 4, each load cell 6 includes a fixed portion 6a fixed to the heavy construction 5, an axle securing portion 6b, and a piezoelectric device (piezo device) 6c sandwiched between the fixed portion 6a and the axle securing portion 6b. Each axle 7 is secured to the outer face of the corresponding axle securing portion 6b in such a manner as to be rotatably supported. A known hub is attached to the axle 7. The wheel 2a of the tire 2 is fastened to the hub. The load cell 6 is configured to measure a load value (axle force) applied to the axle 7 supporting the wheel 2a of the tire 2.

Three-axis accelerometers 11 are attached to the axle securing portions 6b of the left and right load cells 6. As illustrated in FIG. 4, the three-axis accelerometers 11 are paired to be fixed to each of the axle securing portions 6b of the load cells 6. The three-axis accelerometers 11 in each pair are located opposite each other on the upper and lower sides of the corresponding axle securing portion 6b. The three-axis accelerometers 11 are configured to measure accelerations in three axial directions applied to the axial center of the axle securing portion 6b. The accelerations in the three axial directions are an acceleration in the axial direction of the axle 7, and accelerations in directions that are perpendicular to the axial direction of the axle 7. The accelerations in the directions that are perpendicular to the axial direction of the axle 7 are a translational front-rear acceleration and a translational top-bottom acceleration.

The heavy construction 5 is coupled to a rear part of the towing vehicle 4 with a tow bar 12 in between. A rear coupler 13 is fixed to the rear end of the tow bar 12. A front coupler 14 is fixed to the front end of the tow bar 12.

As illustrated in FIGS. 2 and 4, the rear coupler 13 includes a coupling plate 13a and a stiffening member 13b. The coupling plate 13a has a Y shape. The coupling plate 13a is oriented in an inverted Y shape with the rear surface thereof facing the center of the front face of the heavy construction 5. The stiffening member 13b is fixed to the coupling plate 13a. The stiffening member 13b forms a frustum.

Clevis arms 16 are protrusively disposed on the rear surface of the coupling plate 13a, at the three corners of the coupling plate 13a. Clevises 17 are fixed to the front face of the heavy construction 5 that faces the clevis arms 16. The clevises 17 each have a slot extending in the top-bottom direction. The clevis arms 16 are coupled to the clevises 17 with the aid of coupling shafts (not illustrated) around which vibration isolation bushes are attached. The rear end of the tow bar 12 is fixed to the front of the rear coupler 13.

A front coupler 14 is fixed to the front end of the tow bar 12 with a bolt. A front clevis arm 14a projects from the distal end of the front coupler 14. On the other hand, a vehicle-side coupler 21 projects rearward from the vehicle-widthwise center of a rear frame (not illustrated) of the towing vehicle 4. A vehicle-side clevis 22 is disposed at the rear end of the vehicle-side coupler 21.

The vehicle-side clevis 22 is constituted by a rear end portion of a support plate fixed to the lower surface of a rear end portion of the vehicle-side coupler 21, and a rear end portion of a base part of a post 27 included in a lever mechanism 26 to be described below. The post 27 stands on the upper surface of the vehicle-side coupler 21. The rear end portions protrude rearward. The vehicle-side clevis 22 has a groove extending in a horizontal direction. A distal portion of the front clevis arm 14a is coupled to the vehicle-side clevis 22 with a spherical bearing 24 in between such that the front clevis arm 14a is swingable relative to the vehicle-side coupler 21.

The lever mechanism 26 is disposed astride a front end portion of the tow bar 12 and the rear end portion of the vehicle-side coupler 21. The lever mechanism 26 includes the post 27 standing on the rear end portion of the vehicle-side coupler 21. The lever mechanism 26 further includes a lever 28 whose middle portion is supported at an upper portion of the post 27. The lever 28 includes a rear arm 28a and a front arm 28b that are integrated in a single body, and a pin 28c serving as a rotation shaft.

A rear portion of the front arm 28b is supported by the post 27 with the aid of the pin 28c such that the front arm 28b is swingable about a vehicle widthwise axis. The rear arm 28a and the front arm 28b are integrated in a single body. A rod 25 is swingably coupled to a rear portion of the rear arm 28a with a ball joint in between. The swing center of the rod 25 is set on a vertical axis passing through the rotation center of the spherical bearing 24.

A rear end portion of the rod 25 is fixed to the upper end of a stand 29. The stand 29 is fixed to the upper surface of a front portion of the tow bar 12. The upper end of a damper 30 is coupled to a front end portion of the front arm 28b. As illustrated in FIG. 2, the damper 30 includes a pair of dampers 30 disposed on two opposite sides of the vehicle-side coupler 21. The body of each of the dampers 30 is supported in such a manner as to be swingable about the vehicle widthwise axis and with respect to the vehicle-side coupler 21. The upper end of a rod projecting from the body of each damper 30 is swingably secured to a fixing plate 31. The fixing plate 31 is supported by the front end portion of the front arm 28b in such a manner as to be swingable about the vehicle widthwise axis.

The moment arm for the arms 28a and 28b is set to be longer for the front arm 28b than for the rear arm 28a. The dampers 30 are each configured to damp the angular velocity of relative swing between the tow bar 12 and the vehicle-side coupler 21 about the vehicle widthwise axis so that the movement of the heavy construction 5 in the top-bottom direction is damped.

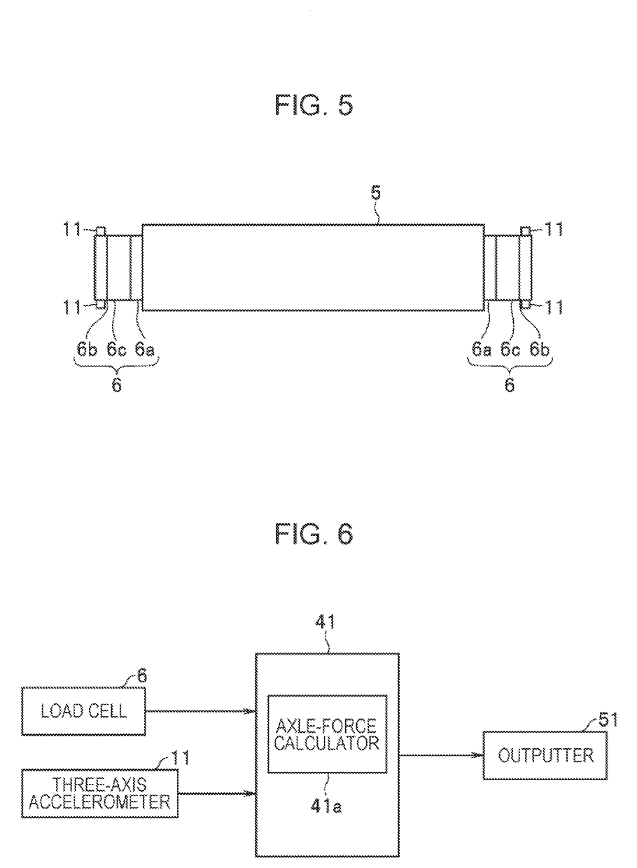

FIG. 5 schematically illustrates how the load cells 6 and the pairs of three-axis accelerometers 11 are attached. As illustrated in FIG. 6, the left and right load cells 6 and the left and right pairs of upper and lower three-axis accelerometers 11 are connected to the input side of an axle-force-measurement arithmetic unit 41. An outputter 51 such as a monitor or a printer is connected to the output side of the axle-force-measurement arithmetic unit 41.

The axle-force-measurement arithmetic unit 41 is constituted by a microcontroller. The microcontroller includes a CPU, a RAM, a ROM, a rewritable nonvolatile memory (flash memory or EEPROM), and peripheral devices. The RAM of the microcontroller is provided as a work area for the CPU, and is configured to temporarily store various data in the CPU. The ROM stores programs, fixed data, and so forth that are necessary for the CPU to execute relevant processes. The CPU is also called a microprocessor (MPU) or a processor. Instead of the CPU, a graphics processing unit (GPU) or a graph streaming processor (GSP) may be used. Alternatively, the CPU, the GPU, and the GSP may be selectively combined.

The axle-force-measurement arithmetic unit 41 includes an axle-force calculator 41a configured to measuring the axle force that is received from each of the tires 2 and applied to the corresponding one of the axles 7.

The axle-force calculator 41a acquires time-series data on the axle force for each of the left and right axles 7 from the load value measured by the corresponding load cell 6. Furthermore, the axle-force calculator 41a acquires time-series data on accelerations (accelerations in the three directions) a applied to the axial center of each axle 7 from the values measured by the corresponding pair of three-axis accelerometers 11, the axial center being located adjacent to the axle securing portion 6b of the corresponding load cell 6. Then, the axle-force calculator 41a calculates an inertial force F based on the accelerations a and a mass m of the axle securing portion 6b of the load cell 6 (F = m·a).

The load cell 6 is a relatively heavy object. In addition, during the travel of the trailer 3 towed by the towing vehicle 4, a relatively large mass is applied to the axle securing portion 6b from the wheel 2a. Therefore, the axle force detected by the load cell 6 is a value damped by an amount corresponding to an inertial force due to the mass applied to the axle securing portion 6b. Hence, the axle-force calculator 41a adds the inertial force F calculated based on the accelerations detected by the three-axis accelerometers 11 to the axle force detected by the load cell 6, thereby calculating a revised axle force, which is highly accurate.

Now, a method of measuring the axle force by using the tire-axle-force measuring apparatus 1 configured as above will be described. First, as illustrated in FIGS. 1 and 2, the tow bar 12 of the trailer 3 with testing tires 2 attached to the left and right axles 7 is coupled to the vehicle-side coupler 21 of the towing vehicle 4 in a predetermined manner. Then, the towing vehicle 4 is caused to travel at a predetermined speed.

The heavy construction 5 is set to have a mass substantially equivalent to the front axle load or rear axle load of an actual vehicle Therefore, a load substantially equal to the actual axle load is applied to the tires 2. The resonance frequency of the heavy construction 5 is set to a value higher than the highest frequency of road noise that is received from the road surface through the tires 2. Therefore, during the travel, the heavy construction 5 does not elastically resonate in the road-noise frequency range.

On the other hand, during the travel, the towing vehicle 4 and the trailer 3 move relative to each other in the top-bottom direction. Because of such a relative vibration between the towing vehicle 4 and the trailer 3 in the top-bottom direction, the lever 28 supported by the post 27 swings about the vehicle widthwise axis. Accordingly, the pair of dampers 30 coupled to the front arm 28b are pushed, whereby the vibration is damped. Consequently, the rigid-body resonance of the trailer 3 itself is suppressed.

The moment arm of the lever 28 is set to be longer for the front arm 28b than for the rear arm 28a. The dampers 30 generate a damping force that depends on the vibration speed. Therefore, by setting the moment arm to be longer for the front arm 28b than for the rear arm 28a, the vibration speed of the dampers 30 increases, and the rigid-body resonance of the trailer 3 itself is suppressed more effectively. Consequently, the ground contact pressure of the tires 2 is prevented from greatly changing.

The rear arm 28a is coupled to the rod 25 with a ball joint in between. The swing center of the rod 25 is set on a vertical axis passing through the rotation center of the spherical bearing 24, which couples the vehicle-side clevis 22 and the front clevis arm 14a. Therefore, even when the towing vehicle 4 is steered to turn, the trailer 3 can follow the towing vehicle 4.

Furthermore, the clevises 17 fixed to a front portion of the heavy construction 5 and the clevis arms 16 disposed on the rear coupler 13 fixed to the rear end of the tow bar 12 are coupled to each other with the aid of coupling shafts (not illustrated) around which vibration isolation bushes are attached. Therefore, the transmission of vibration from the tow bar 12 to the heavy construction 5 is suppressed, and the influence of resonance of the towing vehicle 4 and/or the tow bar 12 is reduced.

Consequently, during the travel of the trailer 3 towed by the towing vehicle 4, the rigid-body vibration that occurs in the trailer 3 itself is suppressed. Therefore, the ground contact pressure of the tires 2 with respect to the road surface does not greatly fluctuate. Furthermore, the vibration transmitted from the towing vehicle 4 to the trailer 3 is reduced.

Hence, during the travel of the trailer 3 towed by the towing vehicle 4, the load cells 6 and the three-axis accelerometers 11 disposed on the heavy construction 5 of the trailer 3 can accurately measure the axle forces and the accelerations applied to the axles 7, without being affected by vibrations from other structures.

Consequently, in the axle-force calculator 41a of the axle-force-measurement arithmetic unit 41, the axle force measured by each of the load cells 6 but damped by an amount corresponding to the inertial force is compensated for with the inertial force F (F = m·a) calculated from the accelerations a measured by the three-axis accelerometers 11. Thus, a highly accurate axle force is obtained.

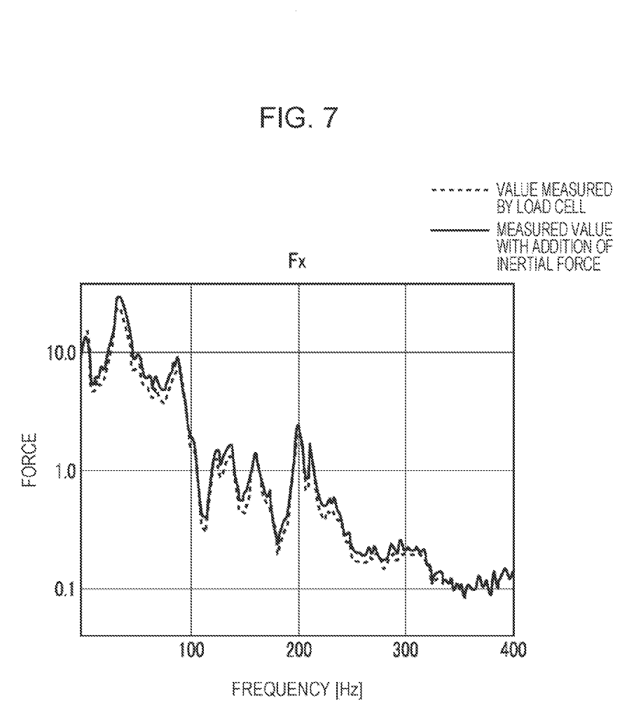

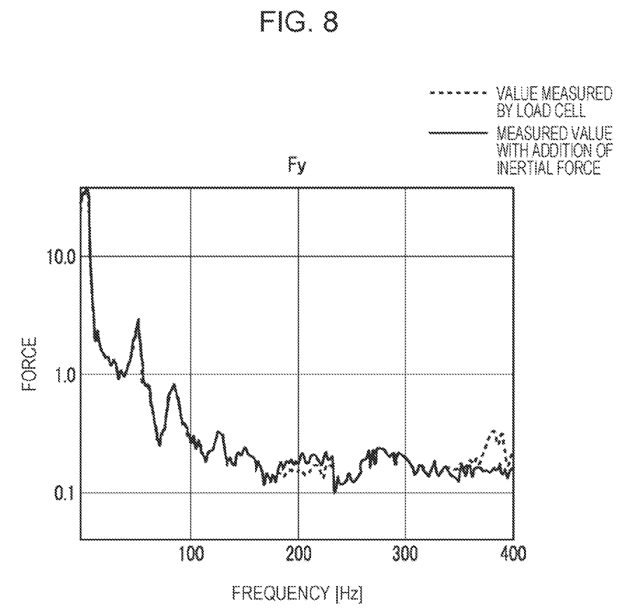

FIG. 7 illustrates the frequency response of the axle force acting in the front-rear direction on the axle 7. FIG. 8 illustrates the frequency response of the axle force acting in a direction along the axle 7. The broken line represents the value measured by the load cell 6. The solid line represents the value obtained by adding an inertial force to the measured value to compensate for the damping due to the inertial force.

In the present embodiment, to eliminate the elastic and rigid-body resonances of the trailer 3 to which the load cells 6 are fixed from the road-noise frequency range for the testing tires 2 of about 20 [Hz] to about 400 [Hz], the outer shape and structure of the trailer 3 are simplified as much as possible to reduce the number of elastic resonance modes, and a predetermined load is applied to the testing tires 2 under the weight of the trailer 3, whereby the increase in the degree of freedom of the entire system is suppressed.

Even if all values of the rigid-body resonance of the trailer 3 are below 20 [Hz], the resonance of the trailer 3 in the vertical direction causes the ground contact pressure of the testing tires 2 to significantly fluctuate. To effectively suppress such a phenomenon, the trailer 3 and the towing vehicle 4 are coupled to each other by using the spherical bearing 24 capable of rocking in all directions, the rocking angular velocity is amplified by using a link mechanism including the lever mechanism 26 constituted by the rod 25 and the lever 28, and the amplified rocking motion is damped by the dampers 30. In addition, to damp the translational dynamic load transmitted from the towing vehicle 4 to the trailer 3 through the spherical bearing 24, the vibration isolation bushes are attached to the coupling shafts provided for the coupling at the clevises 17 included in the trailer 3.

Furthermore, to solve the problem that an inertial force occurs with the vibration of each load cell 6 disposed on the trailer 3 and changes the measured value of the load cell 6 by a non-negligible amount, the plurality of three-axis accelerometers 11 are disposed on the axle securing portion 6b of the load cell 6. Thus, respective vibration accelerations are simultaneously acquired during the traveling test, the vibration acceleration at the axle center is calculated, the inertial force is calculated through the multiplication of the vibration acceleration by the mass of the axle securing portion 6b of the load cell 6, and the measured value of the load cell 6 is compensated for with the inertial force. Consequently, accurate measurement of the axle force and accelerations applied to the axle 7 is achieved.

Note that the disclosure is not limited to the above embodiment. For example, the characteristics of the vibration isolation bushes and the dampers 30 are appropriately selected in accordance with the rigidity, the resonance frequency, and the like of the trailer 3.

According to the disclosure, a load cell is fixed to each of two opposite sides of a heavy construction that are located in the vehicle width direction. The heavy construction is less susceptible to elastic and rigid-body resonances and to the vibration from a towing vehicle within the frequency range of road noise. A plurality of accelerometers are attached to the load cell at positions close to the axle so as to acquire time-history data on the load measured by the load cell and the accelerations measured by the accelerometers during the travel on an actual road surface. An axle-force calculator calculates an inertial force through the multiplication of the accelerations by the mass of the load cell at the position close to the axle. The inertial force is used for compensating for the load value measured by the load cell. Thus, accurate measurement of a dynamic load applied to the axle through a testing tire is achieved, while the influence of the rigid-body resonance of the trailer traveling with the testing tire attached thereto and the influence of the vibration from the towing vehicle are suppressed within a frequency range of about 20 [Hz] to about 400 [Hz].

1. A tire-axle-force measuring apparatus comprising:
a trailer to which testing tires are attached;
a towing vehicle configured to tow the trailer; and
a load cell configured to measure an axle force applied to an axle supporting the tire,
the tire-axle-force measuring apparatus further comprising:
a heavy construction to each of two sides of which the load cell is fixed, the two sides being located opposite each other in a vehicle width direction;
an accelerometer attached to the load cell at a position close to the axle and configured to measure an acceleration acting on an axial center of the axle; and
an axle-force calculator configured to calculate a revised axle force compensated for with an inertial force, the inertial force being the acceleration detected by the accelerometer and multiplied by a mass of the load cell at the position close to the axle, the revised axle force being the sum of the axle force measured by the load cell and the inertial force.

2. The tire-axle-force measuring apparatus according to claim 1,
wherein the trailer comprises a tow bar whose front portion is swingably coupled to the towing vehicle with a spherical bearing in between, and
wherein a rear portion of the tow bar is coupled to the heavy construction with a vibration isolation bush in between.

3. The tire-axle-force measuring apparatus according to claim 2, further comprising:
a damper disposed on a vehicle-side coupler disposed at a rear portion of the towing vehicle, the damper being configured to damp a swing angular velocity of the tow bar with respect to the vehicle-side coupler.

4. The tire-axle-force measuring apparatus according to claim 3, further comprising:
a lever a fulcrum of which is set on the vehicle-side coupler,
wherein a first end of the lever is coupled to an operating portion of the damper,
wherein a second end of the lever is coupled to the tow bar with a rod in between, the rod comprising ball joints at two respective opposite ends, and
wherein a moment arm of the lever is set to be longer on a damper-side portion of the lever than on a tow-bar-side portion of the lever.

5. The tire-axle-force measuring apparatus according to claim 4,
wherein a swing center of one of the ball joints disposed at the two opposite ends of the rod is set on a vertical axis passing through a rotation center of the spherical bearing.
